(19) United States
(12) Patent Application Publication
(10) Pub. No.: US 2022/0204100 A1
(43) Pub. Date: Jun. 30, 2022

(54) Coupleable, Unmanned Ground Vehicles with Coordinated Control

(71) Applicant: Sarcos Corp., Salt Lake City, UT (US)

(72) Inventors: Fraser M. Smith, Salt Lake City, UT (US); Marc X. Olivier, Salt Lake City, UT (US)

(21) Appl. No.: 17/139,878

(22) Filed: Dec. 31, 2020

(51) Int. Cl. B62D 55/065; B25J 9/08; B25J 9/16

(52) U.S. Cl. CPC B62D 55/0655; B60D 1/06; B25J 9/1669; B25J 9/08

(57) ABSTRACT

A robotic system comprises a first robotic crawler having a mobility mechanism for locomotion, a second robotic crawler having a mobility mechanism for locomotion, and at least one coupling mechanism supported by at least one of the first or second robotic crawlers to couple and uncouple the first and second robotic crawlers to and from each other. When coupled together, the first and second robotic crawlers are operable as a unified robotic crawler system in a coordinated drive mode for operational control of respective mobility mechanisms in a coordinated manner. Various operating modes provide for selective control of various aspects of the first and second robotic crawlers, whether coordinated or independent control. The unified robotic crawler system provides greater or enhanced stability of the first and second robotic crawlers. Associated methods are provided herein.

### BACKGROUND

Unmanned ground vehicles, such as tracked, wheeled, or other types of robotic crawlers, are useful for gaining access to areas that are inaccessible and/or dangerous for individuals. Depending upon theft configuration, robotic crawlers can perform various functions, such as using on-board cameras and sensors for imaging and surveillance, and other functions such as using end effectors to perform a task (e.g., diffusing and/or transporting an explosive ordinance). Some robotic crawlers can include a pair of tracked frames coupled together by one or more powered linkages or joints, thus allowing the robotic crawler to move in a snake-like manner along the ground. Because of their narrow profile, such robotic crawlers may be unstable when attempting to perform particular tasks, or they may be somewhat limited in the types or nature of tasks that they can perform due to their configuration. For some tasks that require a certain level of ground stability, a robotic crawler may be entirely incapable of performing such tasks without some kind of assistance.

### SUMMARY

An initial summary of the inventive concepts is provided here and specific examples are described in further detail below. This initial summary is intended to aid readers in understanding the examples more quickly, but is not intended to identify key features or essential features of the examples, nor is it intended to limit the scope of the claimed subject matter.

The present disclosure sets forth a robotic system comprising a first robotic crawler having a mobility mechanism for locomotion; a second robotic crawler having a mobility mechanism for locomotion; and at least one coupling mechanism supported by at least one of the first or second robotic crawlers, the at least one coupling mechanism operable to couple and uncouple the first and second robotic crawlers to and from each other, wherein, when coupled, the first and second robotic crawlers are operable and controllable (via a controller) as a unified robotic crawler system in a coordinated drive mode. When uncoupled, the first and second robotic crawlers are operable and controllable (via the controller) as a separated robotic crawler system.

In one example, each of the first and second robotic crawlers can comprise first and second frame units coupled together by at least one articulated linkage.

In one example, the first frame unit of each of the first and second robotic crawlers are coupleable to each other by the at least one coupling mechanism, such that the respective second frame units of the first and second robotic crawlers are independently movable relative to each other.

In one example, the first frame unit of each of the first and second robotic crawlers are coupleable to each other in a side-by-side manner, the first frame unit of the each of the first and second robotic crawlers being in support of respective tracks or wheels.

In one example, each mobility mechanism of the first and second robotic crawlers can comprise a continuous track.

In one example, the at least one coupling mechanism can comprise an electromagnetic device supported by one of the first or second robotic crawlers, the electromagnetic device being operable to generate a magnetic force between the first and second robotic crawlers to couple them together.

In one example, the electromagnetic device can comprise a variable flux magnetic device operable to vary a magnetic force between the first and second robotic crawlers.

In one example, the at least one coupling mechanism can comprise a rigid structural support removably securable to the first and second robotic crawlers via attachment means.

In one example, the rigid structural support can comprise a cross platform that separates the first and second robotic crawlers by a distance that is greater than a width of one of the first or second robotic crawlers.

In one example, the at least one coupling mechanism can comprise one of a ball and socket mechanism, a hook and loop mechanism, an over-center latch mechanism, or an electro-mechanical coupling mechanism.

In one example, at least one of the first or second robotic crawlers can comprise an end effector. This can be supported by a respective frame unit.

In one example, the at least one coupling mechanism can comprise first and second coupling devices, wherein the first coupling device is supported about an end of the first robotic crawler, and wherein the second coupling device is supported about an end of the second robotic crawler, such that the first and second robotic crawlers are coupleable at their respective ends to form an in-line snake-like configuration.

In one example, the at least one coupling mechanism can comprise first and second coupling devices, wherein the first coupling device is coupled to the at least one articulated linkage of the first robotic crawler, and wherein the second coupling device is coupled to the at least one articulated linkage of the second robotic crawler, such that the first and second robotic crawlers are coupleable about their respective articulated linkages.

In one example, the at least one coupling mechanism can comprise first and second coupling devices, wherein the first coupling device is coupled to the at least one articulated linkage of the first robotic crawler, and wherein the second coupling device is coupled to an end of the second robotic crawler.

In one example, at least one of the first and second robotic crawlers can comprise an end effector.

The present disclosure also sets forth a system for operating first and second robotic crawlers, the system comprising a first robotic crawler comprising first and second frame units, each comprising a mobility mechanism (e.g., a continuous track or wheels) rotatably coupled to the respective first and second frame unit; and at least one articulated linkage coupling the first and second frame units together. The system further comprises a second robotic crawler comprising third and fourth frame units each comprising a mobility mechanism (e.g., a continuous track or wheels) rotatably coupled to the respective third and fourth frame unit; and at least one articulated linkage coupling the third and fourth frame units together. The system further comprises at least one coupling mechanism operable to couple and uncouple the first and second robotic crawlers, wherein, when coupled, the first and second robotic crawlers operate as a unified robotic crawler system; and a controller associated with the first and second robotic crawlers, the controller being configured to operate the unified robotic crawler system in a coordinated drive mode.

In one example, the controller further comprises at least one switch input device for switching between the coordinated drive mode and an uncoupled control mode, and wherein the controller is configured to independently operate the first and second robotic crawlers in the uncoupled control mode when uncoupled from each other.

In one example, the coordinated drive mode includes a full paired drive mode to control operation of the mobility mechanisms of the first, second, third, and fourth frame units.

In one example, the full paired drive mode includes a paired end effector control mode to control operation of an end effector of each of the first and second robotic crawlers to perform a coordinated task, and includes an unpaired effector control mode for independent control of respective end effectors of the first and second robotic crawlers.

In one example, the coordinated drive mode includes a quasi-paired drive mode to control operation of the mobility mechanisms of the only the first and third frame units, such that the mobility mechanisms of the second and fourth frame units are independently controllable in the quasi-paired drive mode.

In one example, the quasi-paired drive mode includes an unpaired auxiliary control mode for independent control of the at least one articulated linkages of the first and second robotic crawlers, and independent control of end effectors of the first and second robotic crawlers.

In one example, the quasi-paired drive mode includes a paired auxiliary control mode for coordinated control of the at least one articulated linkages of both of the first and second robotic crawlers, and for coordinated control of end effectors of the first and second robotic crawlers.

In one example, the controller is configured to operate the unified robotic crawler system in an uncoupled control mode when the first and second robotic crawlers are uncoupled from each other to form a separated robotic crawler system, the uncoupled control mode comprising an uncoupled selective control mode for selective coordinated control of at least one function of the first and second robotic crawlers to perform a common task.

In one example, the uncoupled control mode includes an uncoupled paired control mode for coordinated control of the first and second robotic crawlers to perform a common task.

In one example, the at least one articulated linkage of the first and second robotic crawlers comprise a plurality of powered joint modules coupled together to facilitate actuated movement of the articulated linkage in a plurality of degrees of freedom.

In one example, each mobility mechanism of the first, second, third, and fourth robotic crawlers comprises a continuous track.

The present disclosure further sets forth a method of operating a unified robotic crawler system comprising obtaining first and second robotic crawlers; coupling together the first and second robotic crawlers via at least one coupling mechanism; controlling (via a controller) operation of the first and second robotic crawlers in a coordinated drive mode. The method can further comprise uncoupling the first robotic crawler from the second robotic crawler via operating the at least one coupling mechanism to from a separated robotic crawler system, and controlling (via the controller) the first and second robotic crawlers in an uncoupled control mode.

In one example, the method can further comprise controlling operation of the first and second robotic crawlers in a full paired drive mode, of the coordinated drive mode, to control operation of mobility mechanisms of the first and second robotic crawlers.

In one example, when in the full paired drive mode, the method can further comprise selectively controlling operation of the first and second robotic crawlers in a paired effector control mode to control operation of end effectors of the first and second robotic crawlers, or in an unpaired effector control mode for independent control of end effectors of the first and second robotic crawlers.

In one example, when in the full paired drive mode, the method can further comprise controlling operation of the first and second robotic crawlers in a quasi-paired drive mode, of the coordinated drive mode, to control operation of first and second mobility mechanisms of the first and second robotic crawlers.

In one example, when in the quasi-paired drive mode, the method can further comprise selectively controlling operation of the first and second robotic crawlers in a paired auxiliary control mode to control operation of end effectors and linkages of the first and second robotic crawlers, or in an unpaired auxiliary control mode for independent control of end effectors and linkages of the first and second robotic crawlers.

In one example, the method can further comprise uncoupling the first robotic crawler from the second robotic crawler via the at least one coupling mechanism, and controlling the first and second robotic crawlers in an uncoupled control mode.

In one example, the method can further comprise operating a coupling input device to couple together the first and second robotic crawlers with a magnetic force, wherein the at least one coupling mechanism comprises an electromagnetic device supported by one of the first or second robotic crawlers, and wherein the coupling input device controls application of a magnetic force via the electromagnetic device.

In one example, the method can further comprise operating respective mobility mechanisms of the first and second robotic crawlers in the coordinated drive mode to facilitate locomotion of the first and second robotic crawlers moving as a unified robotic crawler system.

The present disclosure still further sets forth a method of operating a pair of robotic crawlers (e.g., tracked robotic crawlers), comprising operating (via a controller) first and second robotic crawlers, as part of a separated robotic crawler system, in an uncoupled control mode, such that the first robotic crawler moves about a ground surface separately from the second robotic crawler; coupling the first robotic crawler to the second robotic crawler via a coupling mechanism; switching (via the controller) to a coordinated drive mode for coordinated control of the first and second robotic crawlers; and operating (via the controller) the first and second robotic crawlers in the coordinated drive mode to move together about the ground surface.

In one example, the method can further comprise operating a controller (e.g., at the same or from a remote location) to control movement of the first and second robotic crawlers.

In one example, the method can further comprise operating a switch input device of the controller to facilitate switching between the coordinated drive mode and the uncoupled control mode.

In one example, operating the first and second robotic crawlers in the coordinated drive mode can further comprise selectively switching between a full paired drive mode and a quasi-paired drive mode, the full paired drive mode for coordinated control of first and second mobility mechanisms of the first robotic crawler and of second and third mobility mechanisms of the second robotic crawler, and the quasi-paired drive mode for coordinated control of the first and third mobility mechanisms of the first and second robotic crawlers.

In one example, coupling the first robotic crawler to the second robotic crawler comprises physically attaching together the first and second robotic crawlers via the at least one coupling mechanism.

In one example, each of the first and second robotic crawlers can comprise first and second frame units supporting respective mobility mechanisms; and at least one articulated linkage coupling the first and second frame units together.

In one example, the method can further comprise selectively switching between a full paired drive mode and a quasi-paired drive mode, the full paired drive mode for coordinated control of the mobility mechanisms of the first and second frame units, and the at least one articulated linkage, of the first and second robotic crawlers.

In one example, the method can further comprise switching between a paired effector control mode for coordinated control of end effectors of the first and second robotic crawlers and an unpaired effector control mode for independent control of the end effectors when in the full paired drive mode.

### BRIEF DESCRIPTION OF THE DRAWINGS

Features and advantages of the invention will be apparent from the detailed description which follows; taken in conjunction with the accompanying drawings, which together illustrate, by way of example, features of the invention; and, wherein:

FIG. 1 shows a unified robotic crawler system, in accordance with one example of the present disclosure.

FIG. 2 shows the unified robotic crawler system of FIG. 1, illustrating the increased stability of the first and second robotic crawlers when coupled together over that of any one of the two robotic crawlers operating alone.

FIG. 3 shows a generic block diagram of a unified robotic crawler system (which, in one example, can be embodied by the unified robotic crawler system of FIGS. 1 and 2) and various control modes, in accordance with examples of the present disclosure.

FIG. 4 shows a block diagram of a separated robotic crawler system (which, in one example, can be embodied by the first and second robotic crawlers of the unified robotic crawler system of FIGS. 1 and 2 when uncoupled from one another) and various control modes, in accordance with examples of the present disclosure.

FIG. 5 is an isometric view of a robotic crawler, in accordance with an example of the present disclosure.

FIG. 6 is a rear view of first and second robotic crawlers of a unified robotic crawler system, in accordance with one exemplary embodiment.

FIG. 7 illustrates a block diagram of a unified robotic crawler system, in accordance with one example of the present disclosure.

FIG. 8 is block diagram illustrating a computing device that may be used to execute a method for operating a first and second robotic crawlers of the present disclosure, in accordance with one example of the present disclosure.

FIG. 9A is a top down schematic view of first and second robotic crawlers uncoupled from each other and in an uncoupled control mode, in accordance with one example of the present disclosure.

FIG. 9B shows the first and second robotic crawlers of FIG. 9A coupled together and in a coordinated drive mode.

FIG. 10A is a top down schematic view of first and second robotic crawlers uncoupled and in an uncoupled control mode, in accordance with one example of the present disclosure.

FIG. 10B shows the first and second robotic crawlers of FIG. 10A coupled together and in a coordinated drive mode.

FIG. 11 is a top down schematic view of first and second robotic crawlers coupled together and in a coordinated mode, in accordance with one example of the present disclosure.

FIG. 12 is a top down schematic view of the first robotic crawler of Fla 10A coupled together with the first robotic crawler of FIG. 11, these being shown in a coordinated drive mode.

Reference will now be made to the exemplary embodiments illustrated, and specific language will be used herein to describe the same. It will nevertheless be understood that no limitation of the scope of the invention is thereby intended.

### DETAILED DESCRIPTION

As used herein, “adjacent” refers to the proximity of two structures or elements. Particularly, elements that are identified as being “adjacent” may be either abutting or connected. Such elements may also be near or close to each other without necessarily contacting each other. The exact degree of proximity may in some cases depend on the specific context.

The phrase “unified robotic crawler system” is intended to refer to two or more separable robotic crawlers that are physically coupled together by a coupling mechanism, and including at least one controllable function associated with the two or more robotic crawlers for coordinated control thereof. The unified robotic crawler system can further comprise a controller and other components and/or systems to enable operation of the first and second robotic crawlers as discussed herein.

The term “coupling mechanism” is intended to refer to any type of structure or device or assembly or system supported on two or more robotic crawlers that is utilized to physically join or couple together, and to detach or uncouple, the two or more robotic crawlers.

The phrase “coordinated drive mode” is intended to refer to a control mode or method for operational control of at least the mobility mechanisms of two or more robotic crawlers within a unified robotic crawler system for locomotion about a ground surface in a coordinated manner.

The phrase “robotic crawler” is intended to refer to a robotic machine or device capable of moving or crawling along a ground surface, whether manually controllable, autonomously controllable, or controllable via a combination of these, and/or variations thereof. A robotic crawler can comprise one or more frame units and one or more articulating linkages.

The phrase “mobility mechanism” is intended to refer to as the components of a robotic crawler that facilitate and/or enable locomotion of the robotic crawler. In some examples, a mobility mechanism can include all or part of one or more controllable articulated linkage(s) that couple together two or more frame units and their respective ground contacting components (e.g., tracks, wheels, etc.) as part of a robotic crawler.

The phrase “quasi-paired drive mode”, as one sub-operating mode of the coordinated drive mode, is intended to refer to a control mode or method for coordinated control of respective mobility mechanisms of two or more robotic crawlers coupled together for locomotion about a ground surface, and uncoordinated control of other respective mobility mechanisms of the robotic crawlers. The term “pair” is not intended to limit any definition or example herein as being only “two in a pair”; rather, the term “pair” is intended to refer to two or more devices controllable in a coordinated manner (e.g., such as the manner in which Bluetooth communication devices “pair” together two or more electronic devices for communication and/or control purposes). Thus, the term “quasi-paired” infers or suggests that some operational aspects of robotic crawlers of a unified robotic crawler system are not “paired” or controlled in a coordinated manner, and are therefore independently controllable (e.g., linkage(s), end effectors, mobility mechanisms, etc.).

The phrase “unpaired auxiliary control mode”, as one sub-operating mode of the quasi-paired drive mode, is intended to refer to a control mode or method for uncoordinated (i.e., independent) control of two or more auxiliary devices of respective robotic crawlers. An “auxiliary device” can include, but is not limited to, one or more articulated or articulating linkages and/or one or more end effectors. An “end effector” can include, but is not limited to, one or more devices coupled to a portion of a robotic crawler for performing a task (e.g., an end effector such as a gripper, cutter, arm, sensor, etc.). An “articulated linkage” or “articulating linkage” can include, but is not limited to, one or more powered joints as part of a linkage, wherein two structures or assemblies of the linkage of a robotic crawler can be caused to rotate about an axis of rotation.

The phrase “paired auxiliary control mode”, as one sub-operating mode of the quasi-paired drive mode, is intended to refer to a control mode or method for coordinated control of two or more auxiliary devices of respective robotic crawlers.

The phrase “full paired drive mode”, as one sub-operating mode of the coordinated drive mode, is intended to refer to a control mode or method for coordinated control of all of the mobility mechanisms of the respective robotic crawlers of a unified robotic crawler system for locomotion about a ground surface.

The phrase “unpaired effector control mode”, as one sub-operating mode of the full paired drive mode, is intended to refer to a control mode or method for uncoordinated (i.e., independent) control of two or more end effectors of respective robotic crawlers.

The phrase “paired effector control mode”, as one sub-operating mode of the full paired drive mode, is intended to refer to a control mode or method for coordinated control of two or more end effectors of respective robotic crawlers.

The phrase “separated robotic crawler system” is intended to refer to two or more robotic crawlers that are capable of physically coupling together, but are physically uncoupled from each other while still being controllable by the controller of the robotic system.

The phrase “uncoupled control mode” is intended to refer to a control mode or method for operational control of mobility mechanisms of two or more robotic crawlers, of a separated robotic crawler system, for locomotion about a ground surface, either in an uncoordinated or coordinated manner.

The phrase “uncoupled paired control mode”, as one sub-operating mode of the uncoupled control mode, is intended to refer to a control mode or method for coordinated control of mobility mechanisms of respective robotic crawlers when physically uncoupled from each other to achieve a common task or goal.

The phrase “uncoupled selective control mode”, as one sub-operating mode of the uncoupled control mode, is intended to refer to a control mode or method for selective coordinated control of two or more functions of respective robotic crawlers when physically uncoupled from each other, such as to achieve a common or related task or goal.

The phrase “uncoupled asynchronous task mode”, as one sub-operating mode of the uncoupled control mode, is intended to refer to a control mode or method for uncoordinated (i.e., independent) control of all functions of respective robotic crawlers when physically uncoupled from each other, such as to achieve a different or unrelated task or goal.

The term “frame unit” is intended to refer to an assembly or system of components of a robotic crawler for effectuating movement or locomotion of some or all aspects the robotic crawler (e.g.; a frame unit can include a structural support (e.g., a frame or chassis), one or more ground contacting components (e.g., tracks, wheels, and their support components), one or more batteries, computer system(s), radio(s), actuator(s), drive motor(s) and other drive component(s) to effectuate locomotion, sensor(s), respective end effector(s), electronic(s), etc., or a combination of these).

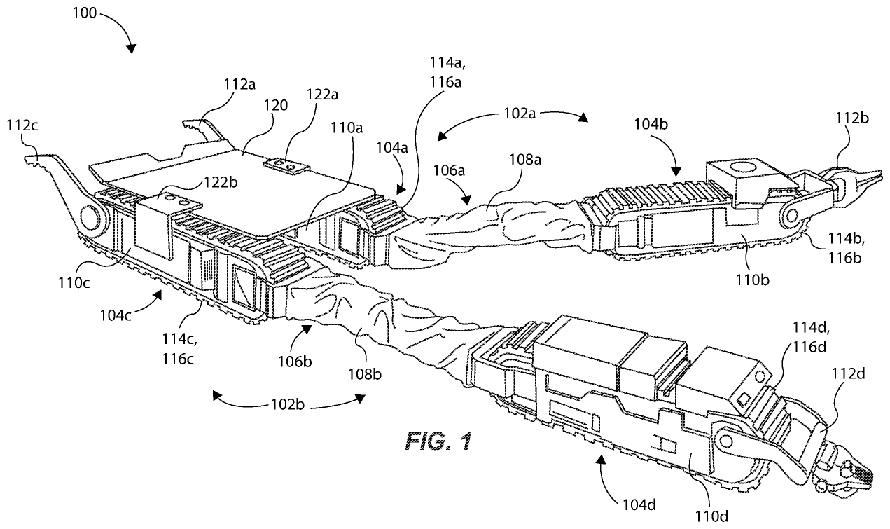

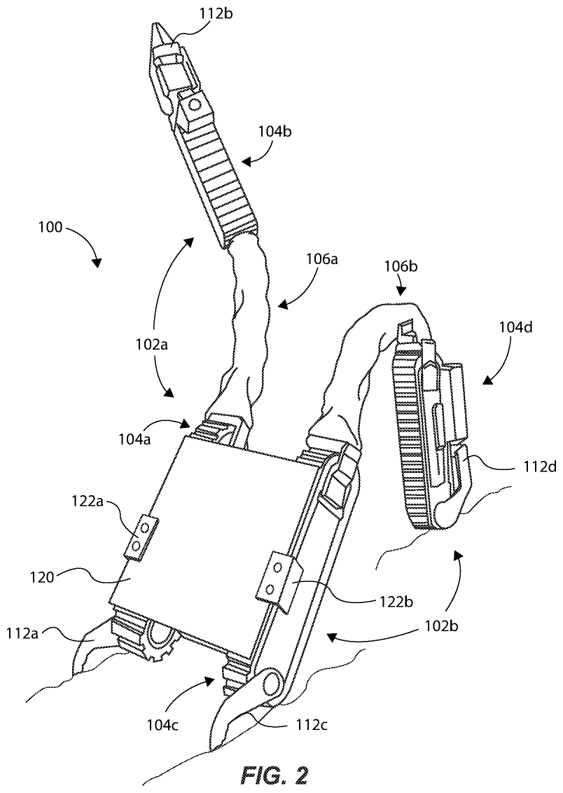

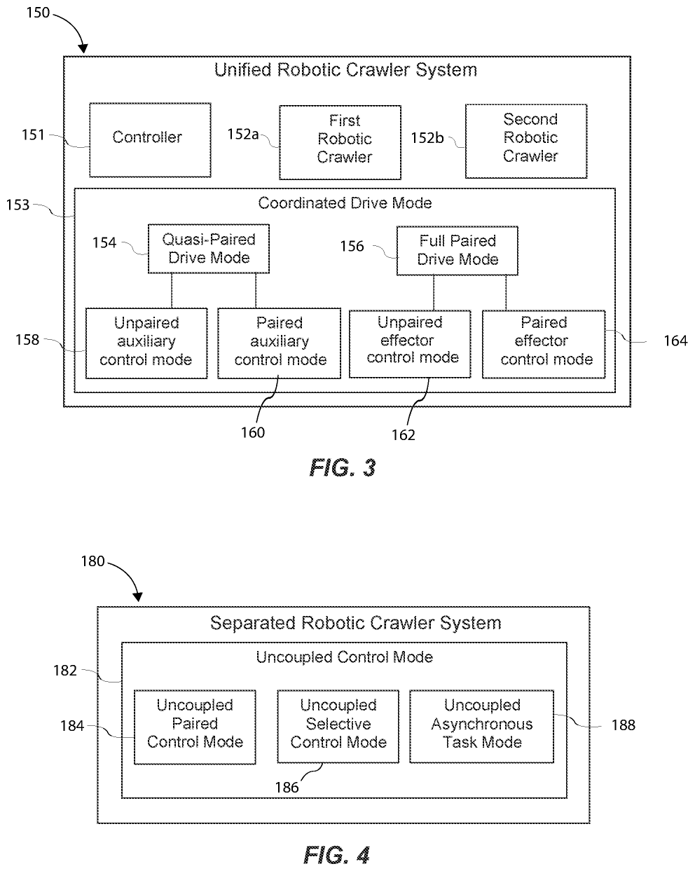

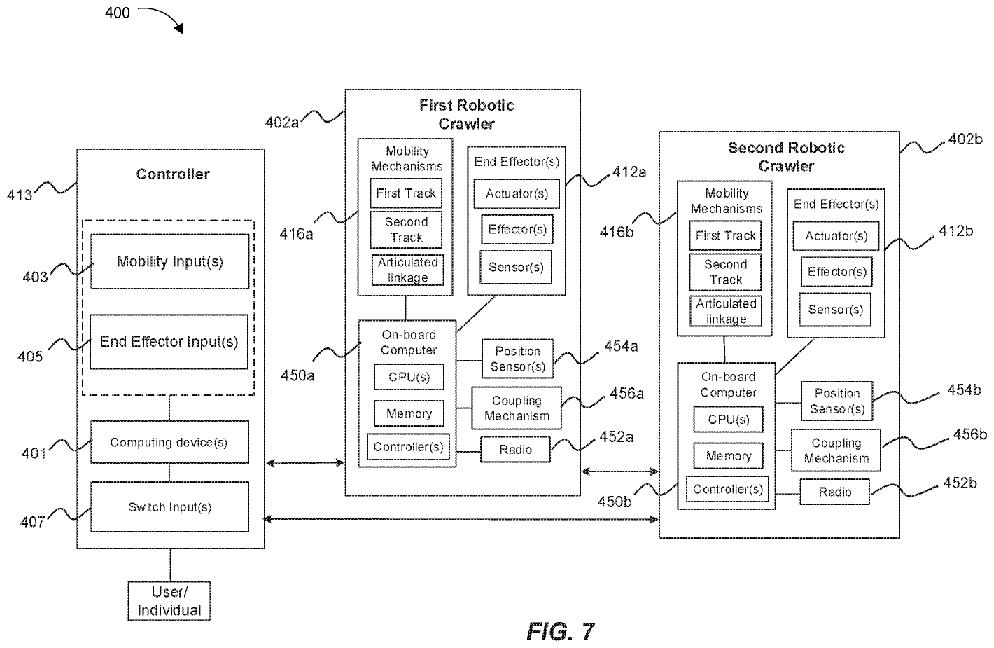

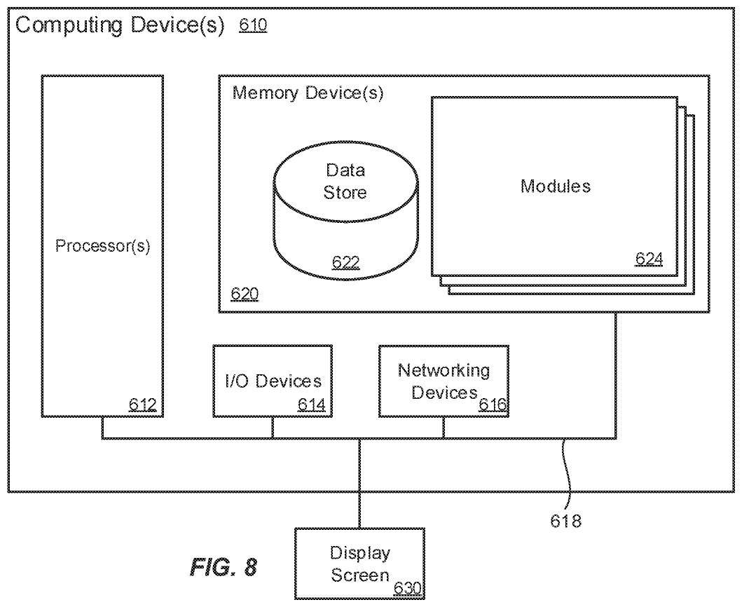

To further describe the present technology, examples are now provided with reference to the figures. In one example, FIGS. 1 and 2 illustrate a robotic system in the form of a unified robotic crawler system 100 (or a portion thereof) that comprises first and second robotic crawlers 102a and 102b physically joined or coupled together by a coupling mechanism 120 and that is operable in a coordinated drive mode (e.g., FIG. 3), such that the first and second robotic crawlers 102a and 102b can be controlled via a controller of the robotic system to move along a ground surface as a single or unified robotic crawler or vehicle. As further detailed below, the first and second robotic crawlers 102a and 102b can be selectively coupled to each other and uncoupled from each other via the coupling mechanism 120 (or other coupling mechanism discussed herein), meaning that the robotic crawlers 102a and 102b can be joined or separated as needed or desired (as determined by an operator in real-time, or via a computer program). When physically uncoupled, the first and second robotic crawlers 102a and 102b, that are otherwise capable of being physically coupled together, can define a separated robotic crawler system (e.g., FIG. 4) where the first and second robotic crawlers are operable via the controller (e.g., the controller 151 of FIG. 3, or controller 413 of FIG. 7) in an uncoupled control mode, as further discussed below. As should be appreciated from the following examples, selectively coupling together individually operable robotic crawlers to generate a unified robotic crawler system provides an advantage of improved or greater stability, increased functionality (e.g., additional available end effectors, additional or enhanced locomotion capabilities, added leverage between certain frame units), and other benefits pertaining to the performing of particular tasks exemplified below, as compared to the stability and functionality of a single robotic crawler operated on its own for a given task. For instance, a single robotic crawler may be unstable (e.g., prone to tipping or falling over) on uneven terrain, thereby increasing the difficulty or risk of failure of a particular mission or task. However, coupling together two or more robotic crawlers in a side-by-side manner (see e.g., FIGS. 1 and 2) increases the stability of the resulting robotic system because a wider mobility base (e.g., the track base (axle track) and/or wheel base) provides greater surface area along a lateral axis (an axis perpendicular to an axis in the direction of travel), thus resulting in more stability (e.g., less prone to tipping or falling) than that of a single robotic crawler.

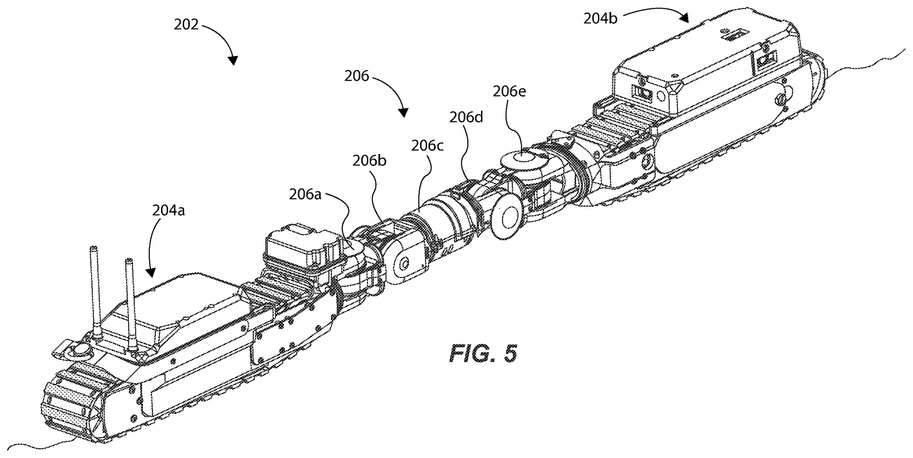

Turning now to the components illustrated in the example of FIGS. 1 and 2, each of the first and second robotic crawlers 102a and 102b can comprise respective first and second frame units 104a-d coupled together by respective articulated linkages 106a and 106b. That is, the first and second frame units 104a and 104b of the first robotic crawler 102a are coupled together by the articulated linkage 106a, and the first and second frame units 104c and 104d of the second robotic crawler 102b are coupled together by the articulated linkage 106b. As indicated, FIGS. 1 and 2 show flexible shrouds or covers 108a and 108b covering the respective articulated linkages 106a and 106b. However, as one example of an articulated linkage, see FIG. 5 showing a robotic crawler 202 having first and second frame units 204a and 204b coupled together by an articulated linkage 206 defined by a plurality of actuator joint modules 206a-e providing a plurality of actuated joints. Such articulated linkage 206 could be incorporated as the articulated linkages 106a and/or 106b of the first and second robotic crawlers 102a and 102b of FIGS. 1 and 2, for instance. The actuator joint modules 206a-e of the articulated linkage 206 can each have one or more support structures and an actuator (e.g., an electric motor) for actuating the respective joint module. Note that each actuator joint module 206a-e can be rotated about one of a respective x, y, or z axis, so that when combined and operated in a controlled manner, the robotic crawler 202 can move in a snake-like manner through various terrain surfaces with each of the actuator joint modules 206a-e providing rotation about their respective axis, at least some of these being different from one another to provide movement in a number of different degrees of freedom. The term “actuator joint module” is intended to refer to as a powered joint that includes components for effectuating rotation about an axis of the rotation of the joint (e.g., EM motor, transmission, sensor(s), feedback loop, etc.).

The robotic crawler 202 of FIG. 5 can be utilized as any of the robotic crawlers disclosed herein, and can include one or more end effectors (not shown in FIG. 5, but see FIGS. 1 and 2 for examples). The robotic crawler 202 can include a number of components for controlling operation of the robotic crawler 202, such as further described regarding FIGS. 3, 4, 7, and 8, and such as further described in U.S. patent application Ser. No. 11/985,336 filed Nov. 13, 2007 (issued as U.S. Pat. No. 8,185,241), which is incorporated by reference herein.

With continued reference to FIGS. 1 and 2, each frame unit 104a-d can include a respective chassis 110a-d that can support a number of components of the respective frame units, such as one or more batteries, computer systems, radios, actuators, drive motors (and other drive components to effectuate locomotion), sensors, respective end effectors (e.g., 112a-d), electronics, and respective means for locomotion, such as continuous tracks (e.g., 114a-d) and their support components (drive wheels, idler or bogey wheels and other rotational supports), wheels, or others, or a combination of these. More specifically, each frame unit 104a-d can include a respective mobility mechanism 116a-d comprising components to facilitate locomotion of the frame unit 104a-d. In some examples, a mobility mechanism can include a motor, one or more drive wheels, one or more bogey or support wheels, an endless or continuous track supported on the one or more drive and one or more bogey or support wheels, a local controller, and any other component for effecting locomotion of the respective frame units 104a-d. Thus, a user, operating a controller (e.g., a remote control type of controller) in communication (e.g., wireless) with one or both of the first and second robotic crawlers 102a and 102b, can control ground movement or locomotion of the first and second robotic crawlers 102a and 102b via controlling their respective mobility mechanisms 116a-d in a coordinated drive mode, as further discussed herein. The user operating the unified robotic crawler system in the coordinated drive mode, via the controller, can also control end effector operation and movement of one or more of the end effectors 112a-d in various control modes, as further discussed herein.

In one aspect, the end effectors 112a-d can comprise any type of dynamic, articulating or jointed end effector, such as grippers, cutters, stabilizer arms, and others. In other examples, particular end effectors can comprise other types of components, such as scanners, sensors, cameras, stabilizer arms, etc.

Note that a particular “mobility mechanism” of the present examples can be associated with just one frame unit of a single robotic crawler (i.e., a robotic crawler not having more than one frame unit or an articulated linkage). For instance, the mobility mechanism for a frame unit (e.g., 104a) can include one track (e.g., 114a) and its motor, drive/bogey wheel, local controller, etc. Alternatively, a particular “mobility mechanism” for a robotic crawler (e.g., 102a) can be defined by a plurality of the components used for locomotion of a particular robotic crawler, such as two frame units (e.g., 104a and 104b) and both tracks (e.g., 114a and 114b) (and their associated motors, drive/bogey wheels, local controllers, etc.) and an articulated linkage (e.g., 106a) (and the associated powered joints of the articulated linkage). Although not shown, those skilled in the art will recognize that a particular mobility mechanism can alternatively comprise a motor, a local controller and two or more wheels, rather than an endless track. Still other types of mobility mechanisms will be apparent to those skilled in the art, and thus those shown in the drawings and discussed herein are not intended to be limiting in any way.

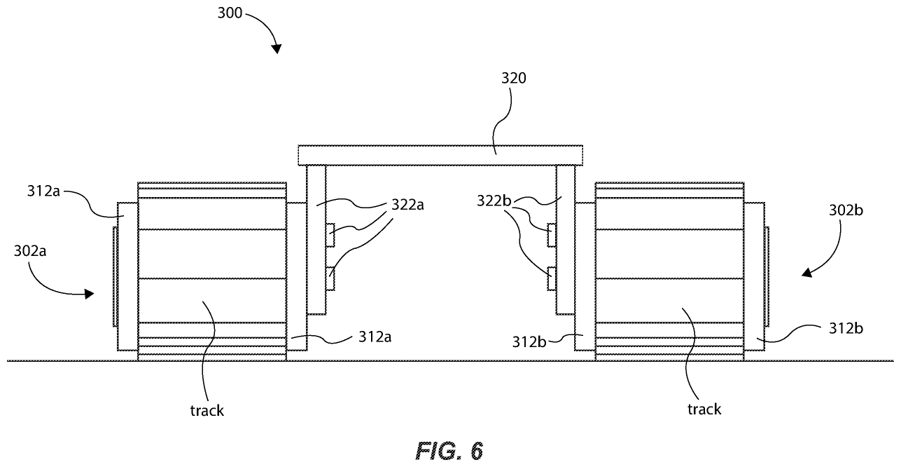

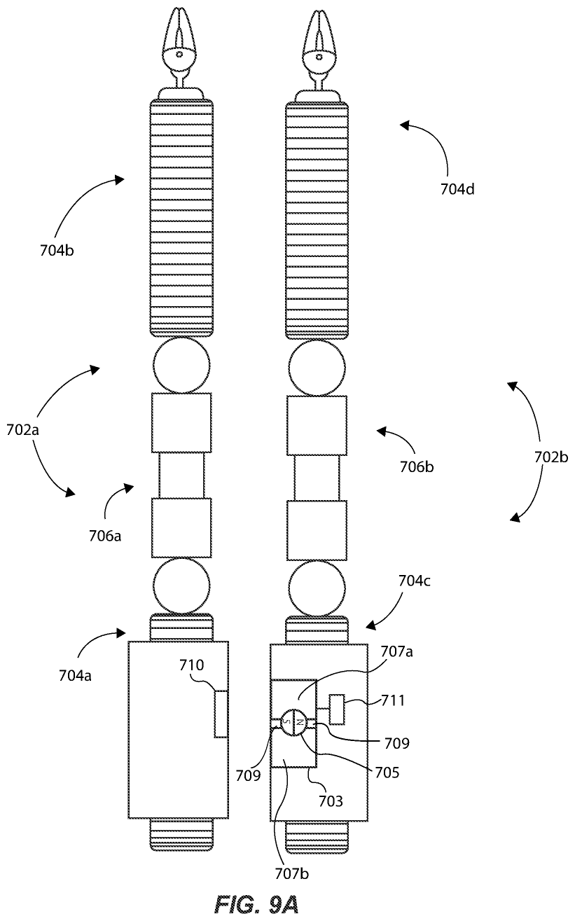

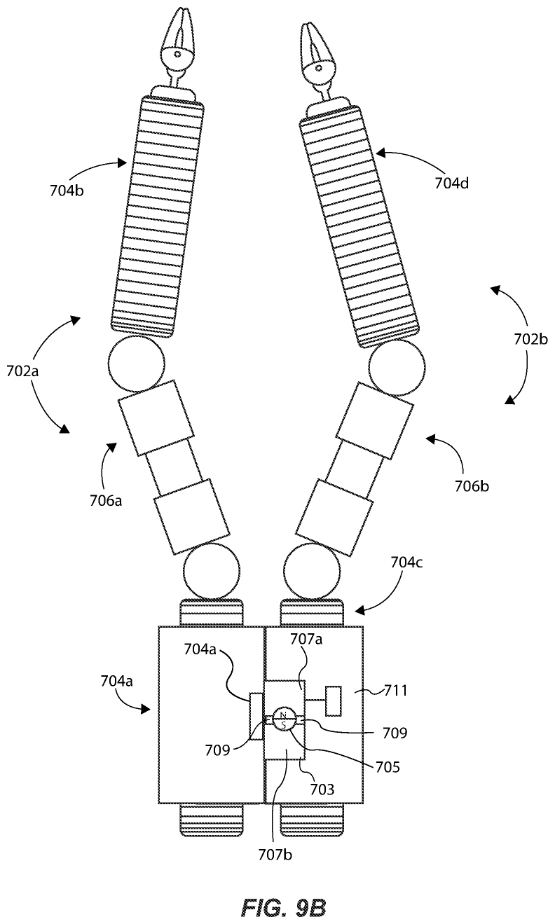

A coupling mechanism can be any type of structural mechanism or system utilized to couple together, and uncouple from each other, one or more robotic crawlers, such as the first and second robotic crawlers 102a and 102b. Indeed, the coupling mechanism can facilitate the selective physical coupling or joining of two or more robotic crawlers, wherein the coupling mechanism also facilitates, selectively, their separation (i.e., the crawlers can be separably jointed or coupled via the coupling mechanism). For instance, a coupling mechanism can comprise a rigid plate or support structure 120 that can be attached to chassis 110a and chassis 110c of the respective frame units 104a and 104c of the respective robotic crawlers 102a and 102b via respective brackets and fasteners 122a and 122b, or by other suitable attachment means (see e.g., FIGS. 6 and 9B). Accordingly, a user can secure together the first and second robotic crawlers 102a and 102b via the coupling mechanism or support structure 120 (and associated attachment means) to form the unified robotic crawler system 100 when the user desires to operate the robotic crawlers 102a and 102b in the coordinated drive mode for a particular task to achieve enhanced functionality and/or stability as compared to operating any single one of the first or second robotic crawlers 102a and 102b by itself, Upon being coupled or joined together, the first and second robotic crawlers 102a and 102b function as a single, unitary robotic crawler due to the rigidity of the coupling mechanism or support structure 120 extending between the respective frame units 104a and 104c of the first and second robotic crawlers 102a and 102b. It should be appreciated that different frame units can be selectively coupled together to form a particular unitary robotic crawler different than shown in FIGS. 1 and 2, For instance, the first frame unit 104a (of the first robotic crawler 102a) can be coupled to the second frame unit 104d (of the second robotic crawler 102b) by any suitable coupling mechanism exemplified herein and in any relative arrangement (e.g., the frame units 104a and 104d can be releasably coupled together in a side-by-side arrangement, in a partial side-by-side arrangement (i.e., the frame units 104a and 104d are positioned partially side-by-side and overlap to some degree in a side-by-side arrangement, but their ends are not necessarily in-line with one another), in an end-to-end arrangement, etc.), such that the second frame unit 104b and the first frame unit 104c are the “free ends” of the resulting unified robotic crawler system that is longer than that shown in FIG. 1. This may provide greater stability for certain tasks, such as crawling along a narrow beam, etc. Further to this concept, any of the frame units 104a-d can be equipped or be capable of coupling to any frame unit of the other robotic crawler (102a or 102b), or additional frame unit(s) of other robotic crawlers (e.g., a third, or fourth, etc. robotic crawler).

Note that the coupling mechanism or support structure 120 is shown more generically as a rigid plate, but it could take many other suitable forms or configurations that provide a support structure or frame that rigidly couples together the chasses 110a and 110c. For instance, a particular coupling mechanism can comprise one or more cross bars. A particular coupling mechanism can be any size, shape, and configuration depending on the configuration of the robotic crawlers and/or the desired task. In some examples, a particular coupling mechanism (e.g., plate or frame or platform) can be configured to receive and support a payload or other object that may be used to achieve a mission, or that may have been retrieved during a mission (e.g., an explosive ordinance). In other examples, a particular coupling mechanism could comprise various mechanisms that allow two or more robotic crawlers to couple and uncouple from each other on demand and without the need for an operator to physically install and/or remove the coupling component (i.e., without requiring an operator to physically or manually couple and uncouple the robotic crawlers). For instance, coupling and uncoupling could be achieved using a coupling mechanism comprising a permanent magnet-based holding force module, where the permanent magnet flux return path can be varied using a small motor, as further exemplified below. Other motorized mechanisms could also readily be implemented as part of a coupling mechanism to allow two or more robotics crawlers to selectively couple and uncouple to each other without the need for an operator to manually install and/or remove some components to achieve physical coupling, although such is contemplated. The availability of such remotely actuated coupling mechanisms is advantageous in situations where one or more robots may take advantage of their snake-like, small cross-sectional area, such as to access a space through small passages (e.g., a tube or an air vent) and then rejoin or again couple themselves together after exiting such passages to create a much more stable/wider (coupled) robotic crawler that can be used to perform more complex tasks that require a higher degree of stability and/or dexterity.

As noted above, the user can uncouple or unsecure the robotic crawlers 102a and 102b from each other by removing the support structure 120 from the chasses 110a and 110c of the respective frame units 104a and 104c of the respective robotic crawlers 102a and 102b when it is desired to operate the robotic crawlers 102a and 102b as a separated robotic crawler system in various associated control modes, as further exemplified below regarding FIG. 4.

Advantageously, when coupled or secured together to form the unified robotic crawler system 100, the first and second robotic crawlers 102a and 102b can stabilize each other because the separably joined first frame units 104a and 104c are physically (and rigidly) secured to each other. In this configuration, the first and second robotic crawlers 102a and 102b can operate together in a manner for improved stability. For example, if the robotic crawlers 102a and 102b comprise endless tracks for locomotion, the speed, direction and on/off timing of each endless track can be controlled, such that the robotic crawlers 102a and 102b act as a single, unitary vehicle. Accordingly, as shown in FIG. 2, when secured or coupled together to form the unified robotic crawler system 100, the first and second robotic crawlers 102a and 102b can be operated together to perform a more complicated task that a single robotic crawler may not be able to perform on its own, such as reaching upwardly to grasp an object with one end effector 112b of frame unit 104b, while being stabilized at various points of ground contact by other frame units and end effectors, which can achieve improved or enhanced mobility due to wider or longer spaced ground contacting points (as compared to a single robotic crawler operating alone).

Further to this concept, various operating modes are shown in FIG. 3 for operating a unified robotic crawler system 150, which is embodied in one example by the unified robotic crawler system 100 of FIGS. 1 and 2 (e.g., and which is also as applicable to robotic systems 100, 300, 400, or other examples). In one example, and as indicated above, the robotic system, which is shown generically in this example as a unified robotic crawler system 150, can include a controller 151, and first and second robotic crawlers 152a and 152b that are coupled together via a coupling mechanism (see e.g., FIGS. 1 and 2) and that are controllable by the controller 151. Indeed, the controller 151 functions to control the operation of the first and second robotic crawlers 151a and 152b in their various operating modes. When coupled together, respective mobility mechanisms of the first and second robotic 152a and 152b are controllable, by the controller 151, in a coordinated manner to effectuate locomotion of the unified robotic crawler system 150. Thus, in the example of FIGS. 1 and 2, when in the coordinated drive mode, at a minimum the mobility mechanisms 116a and 116c are controllable in a coordinated manner to ensure effective locomotion in a direction desired by a user (or effectuated autonomously by the unified robotic crawler system 150) in furtherance of a particular task.

In the coordinated drive mode, the unified robotic crawler system 150 is operable in either a quasi-paired drive mode 154 or a full paired drive mode 156. In the quasi-paired drive mode 154, only the “restrained” mobility mechanisms are to be operated in a coordinated manner (e.g., the mobility mechanisms 116a and 116c that are restrained together by coupling mechanism 120). In this example, unrestrained mobility mechanisms can be independently controlled via the controller 151, such as for potentially separate or different tasks. For instance, mobility mechanisms 116b and 116d are unrestrained from each other because their respective frame units 110b and 110d are not attached or coupled to each other (like as with 110a and 110c). In this operating mode, mobility mechanism 116b can be controlled for locomotion to achieve task A (e.g., crawling up a wall), while mobility mechanism 116d can be separately or independently controlled for locomotion to achieve a separate or different task B (e.g., crawling toward or grasping an object).

When in the quasi-paired drive mode 154, the unified robotic crawler system 150 is further operable in either an unpaired auxiliary control mode 158 or a paired auxiliary control mode 160. The unpaired auxiliary control mode 158 includes uncoordinated control via the controller 151 of two or more auxiliary devices of respective robotic crawlers 152a and 152b. As noted above, an “auxiliary device” can include, but is not limited to, one or more articulated linkages (e.g., 106a, 106b) and/or one or more end effectors (e.g., 112a-d). For instance, in the unpaired auxiliary control mode 158 the end effector 112b can be controlled to achieve task C (e.g., cutting a wire), while end effector 112d can be separately or independently controlled to achieve a separate or different task D (e.g., grasping a pipe to lift). To this end, when in the unpaired auxiliary control mode 158, the articulating linkages (e.g., 106a and 106b) can be also be operated independently, such as controlled to appropriately assist with positioning respective end effectors 112b and 112d to achieve their respective, separate tasks. Conversely, the paired auxiliary control mode 160 includes coordinated control of two or more auxiliary devices (e.g., 106a, 106b, 112a-d) of respective robotic crawlers 152a and 152b (e.g., 102a and 102b), such as to achieve or in furtherance of a common task E. For instance, end effector 112d can be controlled to pick up and pull out a wire from an electronics assembly, while end effector 112b is controlled and positioned to cute the wire to achieve the common task E.

When in the full paired drive mode 156, the unified robotic crawler system 150 can be operable by controlling all of the mobility mechanisms of first and second robotic crawlers 152a and 152b in a coordinated manner. For instance, the mobility mechanisms 116a-d can collectively be controlled via the controller 151 in a coordinated manner to achieve, or in furtherance of, a common task, such as for driving the unified robotic crawler system 150 up a hill. In this way, the speed and velocity of the mobility mechanisms 116a-d work together in a coordinated manner, and therefore do not operate independently from each other in regards to separate tasks. Moreover, when in the full paired drive mode 156, the unified robotic crawler system 150 is further operable in either an unpaired effector control mode 162 or a paired effector control mode 164. The unpaired effector control mode 162 includes uncoordinated control of end effectors of respective robotic crawlers 152a and 152b. For instance, the end effector 112b can be controlled to achieve task C (e.g., cutting a wire), while end effector 112d can be separately or independently controlled to achieve a separate or different task D (e.g., grasping a pipe to lift). Conversely, the paired effector control mode 164 includes coordinated control of two or more end effectors (e.g., 112a-d) of respective robotic crawlers 152a and 152b (e.g., 102a and 102b), such as to achieve or in furtherance of a common task E. For instance, end effector 112d can be controlled to pick up and pull out a wire from an electronics assembly, while end effector 112b is controlled and positioned to cute the wire to achieve the common task E.

The various operational control modes discussed regarding FIG. 3 provide for a more stable robotic crawler system that is less likely to tip over from side-to-side, due to uneven terrain surfaces, for instance. In this manner, the unified robotic crawler system 150, for instance, can travel over areas that would otherwise be inaccessible to a single robotic crawler due to its instability. In other terms, the “track base” (the distance between the tracks along a lateral axis perpendicular or otherwise transverse to a direction of travel) of the unified robotic crawler system 100 is at least twice as wide as that of either of the single robotic crawlers, which provides greater stability, such as from tipping or sliding. Moreover, the low profile height of the unified robotic crawler system 100 (at the frame units 104a and 104c) is relatively low because, in some examples, no other components extend above the profile of the support structure 120, which generates a center of gravity that is below the support structure 120. This helps to prevent the unified robotic crawler system 100 from tipping over due to a higher center of gravity, such as with many robotic devices that have a number of heavy components supported above the top side of the track(s) or wheels (and/or above the axis of rotation of wheels that turn the track(s)).

In some examples, the coordinated drive mode 153 can comprise controlled movements based on one or more inputs from a user or operator of the controller 151 that generates commands that are sent to one or both of the joined robotic crawlers (e.g., 102a and 102b) at the same time, even though the command sent to each crawler may be the same or different. In another example, the coordinated drive mode 153 can comprise controlled movements based on autonomous or semi-autonomous commands, such as those from enhanced stabilization algorithms, traction control algorithms and others, where these function to generate commands to each of the joined robotic crawlers where the commands are not necessarily the same or provided at the same time to the robotic crawlers, although they could be. In this example, although the autonomous commands may or may not be the same, or may or not be provided at the same time, they are at a minimum coordinated with one another due to the physical union of each of the robotic crawlers to one another, such that the robotic crawlers act as a single, unitary vehicle. In still another example, the coordinated drive mode 153 can also comprise controlled movements based on one or more distinct or separate commands sent to one or more of the joined robotic crawlers. In this example, each of the joined robotic crawlers can comprise controllable aspects that can be controlled via the controller 151 separately and independently of any other joined robotic crawler. For example, it may be desirable to send different commands to two joined robotic crawlers to separately and independently control the end effectors of the two joined robotic crawlers. Alternatively, the commands can be sent to one of the robotic crawlers that then transmits specific commands to the other robotic crawler for separate or independent control of aspects of each robotic crawler.

FIG. 4 illustrates various control modes of a robotic system in the form of a separated robotic crawler system 180, which is defined by two or more robotic crawlers that are capable of physically coupling together being physically uncoupled from each other, and that are controllable, via a controller, in in an uncoupled control mode 182 with its associated sub-operating modes. In the uncoupled control mode 182, various aspects of first and second robotic crawlers (e.g., 102a and 102b) can be selectively operated or controlled via the controller (e.g., controller 151 of FIG. 3, or controller 413 of FIG. 7) in a coordinated manner or uncoordinated manner. An uncoupled paired control mode 184 includes coordinated control of mobility mechanisms (e.g., 116a-d) of respective robotic crawlers (e.g., 102a and 102b) to achieve a common task or goal. For instance, a “follow me” command may be input by a user of a controller (e.g., 151 of FIG. 3, 413 of FIG. 7) in which the second robotic crawler is commanded to follow behind the first robotic crawler along a ground surface. In this example, all of the movement and controls for the mobility mechanisms 116a-d and the articulated linkages 106a and 106b are coordinated.

In another mode, an uncoupled selective control mode 186 (of the uncoupled control mode 182), includes selective, coordinated control via the controller of two or more functions of respective robotic crawlers (e.g., 102a and 102b), such as to achieve a common or related task or goal. For instance, end effectors 112b and 112d may be controlled in a coordinated manner to grasp and cut a wire (e.g., task E above), while other controllable aspects are not coordinated, such as control of articulated linkages 106a and 106b. In another mode, an uncoupled asynchronous task mode 188 includes uncoordinated control of all functions of respective robotic crawlers (e.g., 102a and 102b), such as to achieve a different or unrelated task or goal. For instance, the robotic crawler 102a may be driven to one area to image an ordinance, meanwhile the robotic crawler 102b may be driven separately and independently (from robotic crawler 102a) to a separate area for moving an object completely unrelated to the task and control of robotic crawler 102a.

Note that, in an alternative example, each robotic crawler (that can be used in a unified robotic crawler system) can be a single frame unit having a single track (or it can comprise wheels), so that first and second robotic crawlers can be situated side-by-side, and then coupled together via a suitable coupling mechanism exemplified herein. Thus, an articulated linkage and a second frame unit may not be incorporated into a particular robotic crawler. Accordingly, two frame units of two robotic crawlers can be coupled together by at least one coupling mechanism, so that it looks and moves as a single unitary vehicle having a pair of tracks or sets of wheels, or the like.

FIG. 6 shows an alternative, detailed example of first and second robotic crawlers 302a and 302b (rear view) that can be coupled together via a coupling mechanism in the form of a rigid plate or support structure 320 and associated attachment means. The support structure 320 can be attached to inner and opposing structural surfaces or areas of first and second frames or chasses 312a and 312b (“inner” being those structural surfaces or areas that face one another when the first and second robotic crawlers are positioned side by side) via respective brackets and fasteners 322a and 322b. Note that the first and second robotic crawlers 302a and 302b can be the same or similar as the example robotic crawlers of FIGS. 1, 2, and/or 5, so they can include frame units, tracks, etc., as described above. In another example, a coupling mechanism such as a quick-release device(s) can be used to couple together the robotic crawlers of the present disclosure, such as a ball and socket quick release with a compliant device, for instance. In another example, one or more pivoting support structures can be part of the frame unit, and can swing outwardly from an inner side of one or more chasses, and then can be fastened or otherwise secured to an adjacent chassis. Coupling together the chasses 312a and 312b from an inner or inside area of the robotic crawlers 302a and 302b may be useful in scenarios where an upper side of the robotic crawlers 302a and 302b is not available for use, such as when the upper side or area is used to support various components, such as sensors, batteries, computers, etc., such as shown in FIG. 5.

FIG. 7 is a block diagram showing various aspects of a robotic system in the form of a unified robotic crawler system 400 comprising a controller 413 and first and second robotic crawlers 402a and 402b. It is noted that this example and discussion is intended to be applicable to other robotic systems taught herein (e.g., 100, 150, 180, 300, etc.). More specifically, the controller 413 (e.g., vehicle controller) can comprise or include a handheld device or other user-operated device having a computing system for controlling one or both robotic crawlers 402a and 402b (but shown more specifically as first and second robotic crawlers 102a and 102b of FIGS. 1 and 2) when uncoupled from each other, and also when coupled together. The controller 413 can include one or more computing device(s) 401 for receiving input signals, processing information, executing instructions, and transmitting output command signals for controlling the first and/or second robotic crawlers 402a and 402b. For instance, the computing device(s) 401 can receive and process one or more mobility inputs 403 in response to signals generated from user operation of one or more drive input devices (e.g., joysticks, directional control pads) to control ground operation of the selected first and/or second mobility mechanisms 416a and/or 416b (e.g., for locomotion of the frame units 104a-d of the first and second robotic crawlers 102a and 102b). Further to this concept, the mobility inputs 403 can be used to control operation of one or more articulated linkages (i.e., each having powered joint modules) of the first and second robotic crawlers 402a and 402b to further facilitate locomotion thereof, in conjunction with operating the tracks of the mobility mechanisms 416a and/or 416b. As noted elsewhere, the tracks can be replaced with wheels, or even combined with wheels.

The computing devices(s) 401 can receive and process one or more end effector input(s) 405 in response to signals generated from user operation of one or more end effector input devices (e.g., joysticks, buttons, grippers) to control movement or operation of selected one or more end effector(s) 412a and/or 412b (e.g., end effector(s) 112a-d of FIG. 1) of the selected first and/or second robotic crawlers 402a and/or 402b. These input signals associated with mobility input(s) 403 and/or end effector input(s) 405 may be transmitted to the computing devices(s) 401, which can then process such inputs, and then generate appropriate command signals that are transmitted to the first and/or second robotic crawlers 402a and/or 402b for locomotion and end effector usage.

A radio (or other wireless communication device) may be coupled to the computing devices(s) 401 for transmitting such command signals to radios 452a and 452b on the first and second robotic crawlers 402a and 402b. The radio of the controller 413 may also be used to receive feedback signals originating from sensor data on the first and/or second robotic crawlers 402a and 402b, such as frame unit position data, gripper position and load information, image capture information, video captures feeds, articulated joint position and load information, etc.

The controller 413 can comprise one or more switch input(s) 407 communicatively coupled to the computing device(s) 401 and operable by the user to selectively switch between operating modes (e.g., FIGS. 3 and 4) for operating aspects of the first and second robotic crawlers 402a and 402b. For instance, the switch input 407 can be in the form of one or more devices, such as a digital or manual switch or button on a controller device (e.g., handheld controller), or the switch device can be an audio switch controllable by the user's voice operated by voice commands. The switch input 407 can be selected to operate in the uncoupled control mode (e.g., 182, FIG. 4), whereby the user selects operational control over a selected one of the first or second robotic crawlers 402a or 402b. Thus, the user can selectively operate either one of the first or second robotic crawlers 402a or 402b at different times when uncoupled from each other. Then, the user can couple together (or remotely effectuate the coupling of) the first and second robotic crawlers 402a and 402b (e.g., see FIGS. 1, 2, 5, and 9B), and then the user can activate a switch input device that transmits a switch input to the controller 413 to switch from the uncoupled control mode to the coordinated drive mode (e.g., 153, FIG. 3) to facilitate operating the first and second robotic crawlers 402a and 402b in this mode and any associated sub-operating modes.

The controller 413 can comprise software running or installed for execution by the CPU(s) of the controller 400 and/or the first and second robotic crawlers 402a and 402b for facilitating operation of the first and second robotic crawlers 402a and 402b. That is, software comprising a tangible and non-transitory computer readable medium comprising one or more computer software modules configured to direct one or more processors to execute instructions to cause activation or actuation of components of the first and second robotic crawlers 402a and 402b (e.g., mobility mechanisms, end effectors, coupling mechanisms, radios, etc.). Thus, the controller 413 can comprise a combination of software and mechanical devices associated with the first and second robotic crawlers 402a and 402b, as discussed herein.

Each mobility mechanism 416a and 416b can comprise first and second tracks, motor(s) and drive wheels for driving the tracks, and an articulated linkage, as further exemplified herein. Each end effector 412a and 412b can comprise one or more actuators for actuating the respective end effector(s). The actuators can be linear or rotary actuators, and can be operated by electricity, hydraulics, pneumatics, etc. Each end effector 412a and 412b can further comprise one or more of a particular end effector (e.g., gripper, cutter, magnet, scanner, image sensor, etc.), and each end effector can further include sensor(s) (e.g., position, force) for sensing information position and/or force associated with operation of the end effector(s) 412a and 412b. Each of the first and second robotic crawlers 402a and 402b can further comprise an on-board computer 450a and 450b communicatively coupled to the respective mobility mechanisms 416a and 416b and to respective end effector(s) 412a and 412b. Each computer 450a and 450b can include CPU(s), memory, and controller(s) for controlling operation of respective first and second robotic crawlers 402a and 402b.

The first and second robotic crawlers 402a and 402b can comprise respective radios 452a and 452b communicatively coupled to the respective computers 450a and 450b for receiving and sending signals between each other, and between the controller 413. The radios 452a and 452b can be part of a network, which may include any useful computing or signal network, including an intranet the Internet, a local area network (LAN), a wide area network (WAN), a wireless data network, a cell network, a direct RF link, a stateless relay network or any other such network or combination thereof, and may utilize a variety of protocols for transmission thereon, including for example, Internet Protocol (IP), the transmission control protocol (TCP), user datagram protocol (UDP) and other networking protocols. Components utilized for such a system may depend at least in part upon the type of network and/or environment selected. Communication over the network may be enabled by wired, fiber optic, or wireless connections and combinations thereof.

Each of the first and second robotic crawlers 402a and 402b can further comprise one or more position sensors 454a and 454b coupled to the respective computers 450a and 450b for sensing and determining the relative spatial positions (and orientation) of the first and second robotic crawlers 402a and 402b relative to each other. That is, each frame unit (e.g., 104a-d) can have one or more position sensors for determining their spatial positions relative to each other. The position sensors 454a and 454b can comprise one or more of GPS devices (for outdoor use), Visual Inertial Odometry technology (using cameras), RFID technology, or others as will be apparent to those skilled in the art. Position information can then be transmitted to the controller so that the user can be informed of the relative positions of the first and second robotic crawlers.

Each of the first and second robotic crawlers 402a and 402b can further comprise a coupling mechanism 456a and 456b (or a component of a coupling mechanism, such as a fastener, bracket, mounting holes; etc.) for coupling together the first and second robotic crawlers 402a and 402b (e.g., frame units 104a and 104c) for operating in the coordinated drive mode. In one example, the coupling mechanisms 456a and 456b can comprise a magnetic component (e.g., an electromagnet, a ferromagnetic element, a variable flux magnetic device, a pulsed permanent magnet, etc.) supported by the respective first and second robotic crawlers 402a and 402b, and that are attractable to each other to physically couple the first and second robotic crawlers 402a and 402b together when in close proximity. As an electromagnet device, such as a variable flux electromagnet device (FIG. 9A), the CPU of one of the on-board computers 450a or 450b can control activation of the electromagnetic device to selectively couple or uncouple the first and second robotic crawlers 402a and 402b, which can be controlled by the user operating a coupling input device (e.g., button, switch) that facilitates activation and deactivation of the electromagnetic device. Although not specifically shown and described herein, those skilled in the art will recognize other coupling mechanisms that could be implemented, each of which are contemplated herein. For example, a coupling mechanism can include a ball-and-socket type of mechanism, a quick connect mechanism, a hook and loop mechanism, an over center latch mechanism, and other mechanical or electro-mechanical systems or mechanisms that can be operable to physically couple and decouple the first and second robotic crawlers 402a and 402b.

FIG. 8 illustrates a computing device 610 on which modules or components of this technology may execute. A computing device 610 is illustrated on which a high-level example of the technology may be executed. The computing device 610 may include one or more processors 612 that are in communication with memory devices 620. The computing device 610 may include a local communication interface 618 for the components in the computing device. For example, the local communication interface 618 may be a local data bus and/or any related address or control busses as may be desired.

The memory device 620 may contain modules or components 624 that are executable by the processor(s) 612 and data for the modules 624. For example, the memory device 620 may include some software and hardware components that make up aspects of the controller discussed herein. The modules or components 624 may execute the functions described herein. A data store 622 may also be located in the memory device 620 for storing data related to the modules 624 and other applications along with an operating system that is executable by the processor(s) 612.

Other applications may also be stored in the memory device 620 and may be executable by the processor(s) 612. Components or modules discussed in this description that may be implemented in the form of software using high-level programming languages that are compiled, interpreted or executed using a hybrid of the methods.

The computing device may also have access to I/O (input/output) devices 614 that are usable by the computing devices. An example of an I/O device 614 is a display screen 630 that is available to display output from the computing device 610. Another example of an I/O device 614 is one or more drive and arm control input devices, switch input devices, and other I/O devices associated with a controller of the present disclosure. Networking devices 616 and similar communication devices may be included in the computing device. The networking devices 616 may be wired or wireless networking devices that connect to the internet, a LAN, MN, or other computing network.

The components or modules that are shown as being stored in the memory device 620 may be executed by the processor(s) 612. The term “executable” may mean a program file that is in a form that may be executed by a processor 612. For example, a program in a higher level language may be compiled into machine code in a format that may be loaded into a random access portion of the memory device 620 and executed by the processor 612, or source code may be loaded by another executable program and interpreted to generate instructions in a random access portion of the memory to be executed by a processor. The executable program may be stored in any portion or component of the memory device 620. For example, the memory device 620 may be random access memory (RAM), read only memory (ROM), flash memory, a solid state drive, memory card, a hard drive, optical disk, floppy disk, magnetic tape, or any other memory components.

The processor 612 may represent multiple processors and the memory device 620 may represent multiple memory units that operate in parallel to the processing circuits. This may provide parallel processing channels for the processes and data in the system. The local communication interface 618 may be used as a network to facilitate communication between any of the multiple processors and multiple memories. The local communication interface 618 may use additional systems designed for coordinating communication such as bad balancing, bulk data transfer and similar systems.

Some of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components.

A module may also be implemented in programmable hardware devices such as field programmable gate arrays, programmable array logic, programmable logic devices or the like.

Modules may also be implemented in software for execution by various types of processors. An identified module of executable code may, for instance, comprise one or more blocks of computer instructions, which may be organized as an object, procedure, or function. Nevertheless, the executables of an identified module need not be physically located together, but may comprise disparate instructions stored in different locations which comprise the module and achieve the stated purpose for the module when joined logically together.

Indeed, a module of executable code may be a single instruction, or many instructions and may even be distributed over several different code segments, among different programs and across several memory devices. Similarly, operational data may be identified and illustrated herein within modules and may be embodied in any suitable form and organized within any suitable type of data structure. The operational data may be collected as a single data set, or may be distributed over different locations including over different storage devices. The modules may be passive or active, including agents operable to perform desired functions.

The technology described here may also be stored on a computer readable storage medium that includes volatile and non-volatile, removable and non-removable media implemented with any technology for the storage of information such as computer readable instructions, data structures, program modules, or other data. Computer readable storage media include, but is not limited to, a non-transitory machine readable storage medium, such as RAM, ROM, EEPROM, flash memory or other memory technology, CD-ROM, digital versatile disks (DVD) or other optical storage, magnetic cassettes, magnetic tapes, magnetic disk storage or other magnetic storage devices, or any other computer storage medium which may be used to store the desired information and described technology.

The devices described herein may also contain communication connections or networking apparatus and networking connections that allow the devices to communicate with other devices. Communication connections are an example of communication media. Communication media typically embodies computer readable instructions, data structures, program modules and other data in a modulated data signal such as a carrier wave or other transport mechanism and includes any information delivery media. A “modulated data signal” means a signal that has one or more of its characteristics set or changed in such a manner as to encode information in the signal. By way of example and not limitation, communication media includes wired media such as a wired network or direct-wired connection and wireless media such as acoustic, radio frequency, infrared and other wireless media. The term computer readable media as used herein includes communication media.

FIGS. 9A-12 show various robotic crawlers from top-down schematic views to illustrate different ways of coupling together first and second robotic crawlers to form a unified robotic crawler system. Note that these examples are schematic illustrations of robotic crawlers each having two frame units coupled together by an articulated linkage, but it should be appreciated that each of the robotic crawlers of FIGS. 9A-12 can have some or all of the components of any of the robotic crawlers exemplified herein, such as those described above and shown in FIGS. 1-8.

More specifically, FIGS. 9A and 9B illustrate first and second robotic crawlers 702a and 702b that are coupleable together (FIG. 9B) by a magnetic force via a variable flux magnetic device 703 (e.g., a form of a coupling mechanism). Alternatively, other magnetic devices or components could be implemented, such as one that utilizes a pulsed permanent magnet (i.e., an electropermanent magnet). The first robotic crawler 702a can have two frame units 704a and 704b coupled together by an articulated linkage 706a (e.g., including a plurality of powered joint modules operable in different axes of rotation). The frame unit 704a can support or house or comprise a ferromagnetic element 710, which can be situated near one lateral side of the first robotic crawler 702a, and which can be inside or outside of a chassis of the frame unit 704a (or the ferromagnetic element 710 can be part of the chassis or other metal component of the frame unit 704a). The second robotic crawler 702b can also comprise two frame units 704c and 704d coupled together by an articulated linkage 706b (e.g., including a plurality of powered joint modules operable in different axes of rotation). The frame unit 704c can support a variable flux magnetic device 703 for magnetically attracting the ferromagnetic element 710 to couple together the first and second robotic crawlers 702a and 702b before or during operation in the coordinated drive mode to form a unified robotic crawler system having free ends (e.g., articulated linkages 706a and 706b, and frame units 704b and 704d) extending from the coupling mechanism, similar to those discussed above and shown in FIGS. 1-2.

The variable flux magnetic device 703 can include a magnet 705 and ferromagnetic material 707a and 707b disposed on opposite sides of the magnet 705. The ferromagnetic material 707a and 707b can be separated by a non-ferromagnetic magnetic material 709. In one aspect, the ferromagnetic material 707a and 707b can be a ferrous material (e.g., soft iron) and the non-ferromagnetic material 709 can be a non-ferrous material (e.g., brass, aluminum, acrylic, and other). The ferromagnetic material 707a and 707b and the non-ferromagnetic material 709 can form an opening or a cavity to receive the magnet 705. The magnet 705 can be a permanent magnet or an electromagnet having north and south polar regions, as graphically illustrated by N and S, respectively.

The strength of the magnetic force of the magnet 705 can be made variable depending upon the orientation or position of the magnet 705, and particularly the north and south polar regions. For example, the illustrated position of the magnet 705 in FIG. 9A, and particularly the north and south polar regions, places the north and south polar regions in a vertical orientation in the figure and in line with the non-ferromagnetic material 709 disconnecting the flux return path, which functions to turn the magnet off. In this “full off” position, no magnetic force is registered or produced through the magnet 705. In this way, the first robotic crawler 702a is not magnetically attracted or coupled to the second robotic crawler 702b, so that they can be operated and controlled separately and decoupled from each other. Conversely, as illustrated in FIG. 9B, orienting the magnet 705 so that the north and south polar regions are in-line with the ferromagnetic material 707a and 707b establishes a flux return path and causes the magnet 705 to produce a maximum magnetic force or strength output, which magnetically couples together the first and second robotic crawlers 704a and 704b via the variable flux magnetic device 703 and the ferromagnetic material or component 710 being magnetically attracted to each other. Orienting the magnet 705 in this “full on” position can be accomplished, for example, by rotating the magnet 705 in a direction such that the north and south polar regions are proximate to the ferromagnetic material 707a and 707b, as shown in FIG. 9B.

As indicated above, in one aspect, selectively controlling the rotation of the magnet 705 can be used to selectively increase and decrease the strength or intensity of the magnetic force of the magnet 705. Specifically, causing the magnet 705 to be positioned in one of an infinite number of positions between the “full on” and “full off” positions can enable a magnetic force of a lesser degree as compared to the magnet's “full on” or full powered position. In these in-between positions, the magnetic flux extends partially through the ferromagnetic material 707a and 707b and the ferrimagnetic material 709 to produce a reduced magnetic force. Continuously varying the magnet 705 position between these positions effectively functions to vary the strength of the magnetic force, if desired by the user for a particular application.

The variable flux magnet device 703 can also include an actuator 711 (e.g., small electric motor) operably coupled to the magnet 705 to cause rotation of the magnet 705. As previously discussed, the rotation of the magnet 705 can function to adjust the strength of the magnetic force. Accordingly, through user or computer control of the rotation imparted to the magnet 705 by the actuator 711, the magnetic force of the magnet 705 can be adjusted and controlled. Moreover, the actuator 711 can function to maintain the achieved magnetic force for any given period of time. It is contemplated that any suitable actuator type may be used, such as, but not being limited to, electrical actuators, hydraulic actuators, rotary actuator, pneumatic actuators, motors, etc.

Varying the magnetic force in this manner may be beneficial to generate a greater or maximum magnetic force that may be required to maximize the stability of the coupling interface between the first and second robotic crawlers 702a and 702b, such as when performing a task that imparts high loads onto one or both of the robotic crawlers 702a and 702b. Note that two or more variable flux magnetic devices can be supported by a particular robotic crawler, such as one variable flux magnetic device at opposing ends of a particular frame unit, which may increase or improve stability of the magnetic coupling interface between a pair of robotic crawlers. Further note that one or more robotic crawlers can merely include permanent magnet(s), so that when the robotic crawlers are situated near each other (e.g., a few inches) laterally in a side-by-side manner, the magnet(s) attract to each other, thereby automatically magnetically coupling the robotic crawlers together. The magnetic force may be relatively low (e.g., 10 pounds), so that a user, or one of the robotic crawlers, can pull apart frame units from each other to overcome the magnetic force to uncouple the frame units of the robotic crawlers from each other.

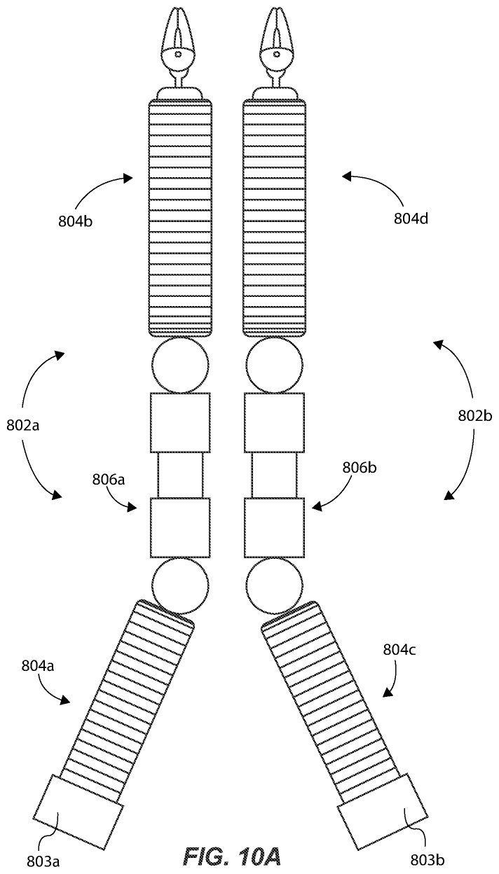

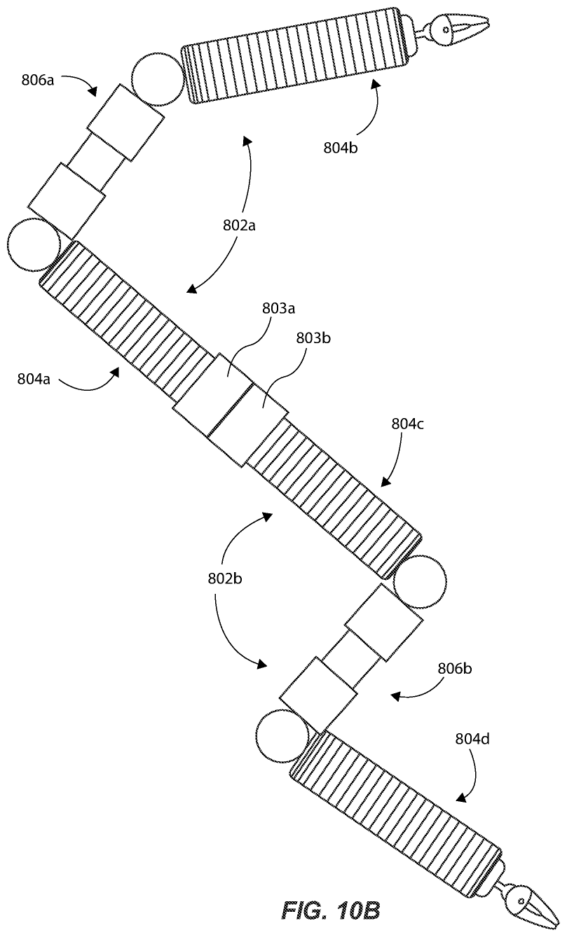

FIGS. 10A and 10B illustrate first and second robotic crawlers 802a and 802b that are uncoupled from each other and operable in an uncoupled control mode (FIG. 10A), and coupled together via coupling mechanisms 803a and 803b to form a unified robotic crawler system operable in a coordinated drive mode (FIG. 10B), The first robotic crawler 802a can have two frame units 804a and 804b coupled together by an articulated linkage 806a (e.g., a plurality of powered joint modules operable in different axes of rotation). The frame unit 804a can support the first coupling mechanism 803a at a distal end of the frame unit 804a, which can be a magnet, ferromagnetic material, variable flux magnetic device, or a support structure for facilitating coupling to another support structure, or any other suitable coupling device or mechanism. Similarly, the second robotic crawler 802b can also comprise frame units 804c and 804d coupled together by an articulated linkage 806b (e.g., a plurality of powered joint modules operable in different axes of rotation). The frame unit 804c of the second robotic crawler 802a can support the second coupling mechanism 803b at a distal end of the frame unit 804c that is operable with the first coupling mechanism 803a to facilitate coupling together the first and second robotic crawlers 802a and 802b (FIG. 10B) for operation in the coordinate drive mode. Thus, as shown in FIG. 10B, ends of the robotic crawlers 802a and 802b can be coupled together to form a unified robotic crawler system in the form of an in-line, longer snake-like robotic crawler that is operable as a single robotic crawler having four tracks and a plurality of articulated linkages. The unified robotic crawler system shown in this example comprises two free ends extending in opposite directions from one another from the coupling mechanisms 803a and 803b, the free ends each being defined by the articulating linkages 806a and 806b and the frame units 804b and 804d, respectively, the frame units 804b and 804d having respective mobility mechanisms. For example, the first free end can comprise, or be defined by, the articulating linkage 806a and the frame unit 804b; and the second free end can comprise, or be defined by, the articulating linkage 806a and the frame unit 804d. This can be useful for a task where both robotic crawlers must travel through a pipe or other small area together, while benefiting from the advantage of having a longer snake-like body for improved stability and maneuverability. After traveling in this manner to a certain location, the robotic crawlers can be uncoupled from each other for operation individually and separately in the uncoupled control mode. Note that the coupling mechanisms 803a and 803b can comprise another mechanical joint or linkage that adds another degree of freedom of movement of the joined robotic crawlers 802a and 802b.

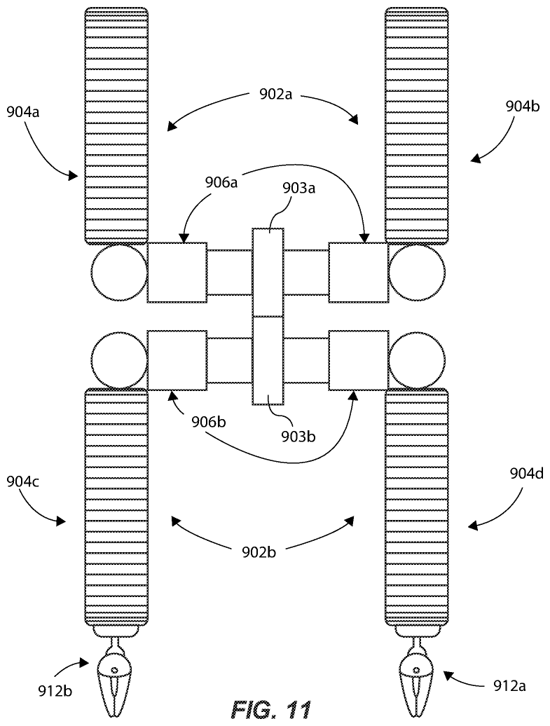

FIG. 11 illustrates first and second robotic crawlers 902a and 902b that are coupled together via coupling mechanisms 903a and 903b to form a unified robotic crawler system operable in a coordinated drive mode. The first robotic crawler 902a can have two frame units 904a and 904b coupled together by an articulated linkage 906a (e.g., a plurality of powered joint modules operable in different axes of rotation). The first coupling mechanism 903a can be supported between adjacent joint modules of the articulated linkage 906a. The first coupling mechanism 903a can be a magnet, ferromagnetic material, variable flux magnetic device, or a support structure configured to be coupled to another support structure, or any other suitable coupling device or mechanism. Similarly, the second robotic crawler 902b can also comprise frame units 904c and 904d coupled together by an articulated linkage 906b (e.g., a plurality of powered joint modules operable in different axes of rotation). The second coupling mechanism 903b can similarly be supported between adjacent joint modules of the articulated linkage 906b, and that is operable and coupleable with the first coupling mechanism 903a to facilitate coupling together the first and second robotic crawlers 902a and 902b for operation in the coordinated drive mode. Thus, middle or intermediate areas or sections of each of the robotic crawlers 902a and 902b can be coupled together to form a unified robotic crawler system in the form of a single robotic crawler having greater stability that just one robotic crawler. This may be beneficial to stabilize the second robotic crawler 902b while it performs tasks with end effectors 912a and 912b, such as lifting a heavier load that requires greater ground support than just one robotic crawler can provide on its own. In this example, the unified robotic crawler system comprises four free ends, each one being comprised of at least a portion of the articulated linkages 906a and 906b, respectively, and frame units 904a, 904b, 904c, and 904d, respectively, the frame units 904a, 904b, 904c, and 904d each having a mobility mechanism (e.g., a continuous track). For example, the first free end can comprise, or be defined by, a portion of the articulating linkage 906a and the frame unit 904a; the second free end can comprise, or be defined by, a portion of the articulating linkage 906a and the frame unit 904b; the third free end can comprise, or be defined by, a portion of the articulating linkage 906b and the frame unit 904c; and the fourth free end can comprise, or be defined by, a portion of the articulating linkage 906b and the frame unit 904d.

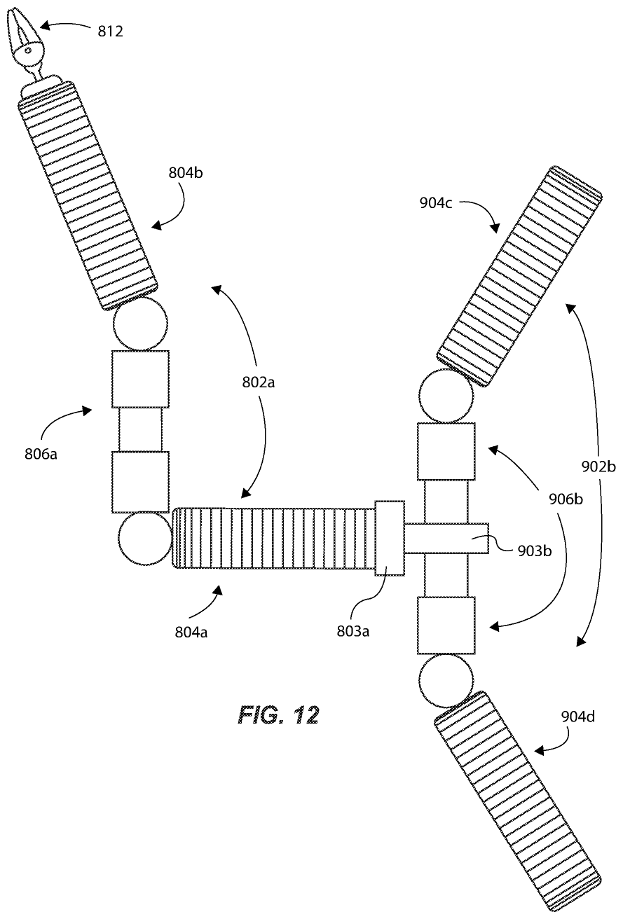

FIG. 12 illustrates a combination of the first robotic crawler 802a (from FIG. 10A) and the second robotic crawler 902b (from FIG. 11) that are coupled together via coupling mechanisms 803a and 903b and in a coordinated drive mode. Thus, an end of the first robotic crawler 802a can be coupled to a middle area of the second robotic crawler 902b (via coupling mechanisms 803a and 903b). This may be beneficial to stabilize one robotic crawler 802a with the other robotic crawler 903b (where frame units 904c and 904d are on the ground), while some or most of the robotic crawler 802a is lifted upwardly from the ground to perform a task with an end effector 812, such as reaching a payload or other item that is higher off the ground that would otherwise be reachable or liftable with a single robotic crawler. In this example, the unified robotic crawler system comprises three free ends, each one being comprised of at least a portion of the articulated linkages 806a and 906b, respectively, and frame units 804b, 904c, 904d, respectively, the frame units 804b, 904c, and 904d each having a mobility mechanism (e.g., a continuous track). For example, the first free end can comprise, or be defined by, a portion of the articulating linkage 806a and the frame unit 804b; the second free end can comprise, or be defined by, a portion of the articulating linkage 906b and the frame unit 904c; the third free end can comprise, or be defined by, a portion of the articulating linkage 906b and the frame unit 904d.

Reference was made to the examples illustrated in the drawings and specific language was used herein to describe the same. It will nevertheless be understood that no limitation of the scope of the technology is thereby intended. Alterations and further modifications of the features illustrated herein and additional applications of the examples as illustrated herein are to be considered within the scope of the description.

Although the disclosure may not expressly disclose that some embodiments or features described herein may be combined with other embodiments or features described herein, this disclosure should be read to describe any such combinations that would be practicable by one of ordinary skill in the art. The use of “or” in this disclosure should be understood to mean non-exclusive or, i.e., “and/or,” unless otherwise indicated herein.

Furthermore, the described features, structures, or characteristics may be combined in any suitable manner in one or more examples. In the preceding description, numerous specific details were provided, such as examples of various configurations to provide a thorough understanding of examples of the described technology. It will be recognized, however, that the technology may be practiced without one or more of the specific details, or with other methods, components, devices, etc. In other instances, well-known structures or operations are not shown or described in detail to avoid obscuring aspects of the technology.

Although the subject matter has been described in language specific to structural features and/or operations, it is to be understood that the subject matter defined in the appended claims is not necessarily limited to the specific features and operations described above. Rather, the specific features and acts described above are disclosed as example forms of implementing the claims. Numerous modifications and alternative arrangements may be devised without departing from the spirit and scope of the described technology.

What is claimed is:

1. A robotic system comprising:
a first robotic crawler having a mobility mechanism for locomotion;
a second robotic crawler having a mobility mechanism for locomotion; and
at least one coupling mechanism supported by at least one of the first or second robotic crawlers; the at least one coupling mechanism operable to couple and uncouple the first and second robotic crawlers,
wherein, when coupled together, the first and second robotic crawlers are operable as a unified robotic crawler system in a coordinated drive mode.

2. The robotic system of claim 1, wherein each of the first and second robotic crawlers comprises first and second frame units coupled together by at least one articulated linkage.

3. The robotic system of claim 2, wherein the first frame unit of each of the first and second robotic crawlers are coupleable to each other by the at least one coupling mechanism, such that the respective second frame units of the first and second robotic crawlers are independently movable relative to each other.

4. The robotic system of claim 3, wherein the first frame unit of each of the first and second robotic crawlers are coupleable to each other in a side-by-side manner, the first frame unit of the each of the first and second robotic crawlers being in support of respective tracks, wheels or a combination of these.

5. The robotic system of claim 1, wherein each mobility mechanism of the first and second robotic crawlers comprises a continuous track.

6. The robotic system of claim 1, wherein the at least one coupling mechanism comprises an electromagnetic device supported by one of the first or second robotic crawlers, the electromagnetic device being operable to generate a magnetic force between the first and second robotic crawlers to couple them together.

7. The robotic system of claim 6, wherein the electromagnetic device comprises a variable flux magnetic device operable to vary a magnetic force between the first and second robotic crawlers.

8. The robotic system of claim 1, wherein the at least one coupling mechanism comprises a rigid structural support removably securable to the first and second robotic crawlers via attachment means.

9. The robotic system of claim 8, wherein the rigid structural support comprises a cross platform that separates the first and second robotic crawlers by a distance that is greater than a width of one of the first or second robotic crawlers.

10. The robotic system of claim 1, wherein the at least one coupling mechanism comprises one of a ball and socket mechanism, a hook and loop mechanism, an over-center latch mechanism, or an electro-mechanical coupling mechanism.

11. The robotic system of claim 1, wherein at least one of the first or second robotic crawlers comprises an end effector.

12. The robotic system of claim 1, wherein the at least one coupling mechanism comprises first and second coupling devices, wherein the first coupling device is supported about an end of the first robotic crawler, and wherein the second coupling device is supported about an end of the second robotic crawler, such that the first and second robotic crawlers are coupleable at their respective ends to form an in-line snake-like configuration.

13. The robotic system of claim 2, wherein the at least one coupling mechanism comprises first and second coupling devices, wherein the first coupling device is coupled to the at least one articulated linkage of the first robotic crawler, and wherein the second coupling device is coupled to the at least one articulated linkage of the second robotic crawler, such that the first and second robotic crawlers are coupleable about their respective articulated linkages.

14. The robotic system of claim 2, wherein the at least one coupling mechanism comprises first and second coupling devices, wherein the first coupling device is coupled to the at least one articulated linkage of the first robotic crawler, and wherein the second coupling device is coupled to an end of the second robotic crawler.

15. The robotic system of claim 2, wherein at least one of the first and second robotic crawlers comprises an end effector supported distally about a respective second frame unit.

16. A system for operating first and second robotic crawlers, the system comprising:
a first robotic crawler comprising:
first and second frame units, each in support of a mobility mechanism; and
at least one articulated linkage coupling the first and second frame units together;
a second robotic crawler comprising:
third and fourth frame units, each in support of a mobility mechanism; and
at least one articulated linkage coupling the third and fourth frame units together;
at least one coupling mechanism supported about the first and second robotic crawlers, the at least one coupling mechanism operable to couple and uncouple the first and second robotic crawlers, wherein, when coupled, the first and second robotic crawlers operate as a unified robotic crawler system; and
a controller associated with the first and second robotic crawlers, the controller configured to operate the unified robotic crawler system in a coordinated drive mode.

17. The system of claim 16, wherein the controller further comprises at least one switch input device for switching between the coordinated drive mode and an uncoupled control mode, and wherein the controller is configured to independently operate the first and second robotic crawlers in the uncoupled control mode when uncoupled from each other.

18. The system of claim 16, wherein the coordinated drive mode includes a full paired drive mode to control operation of the mobility mechanisms of the first, second, third, and fourth frame units.

19. The system of claim 18, wherein the full paired drive mode includes a paired effector control mode to control operation of an end effector of each of the first and second robotic crawlers to perform a coordinated task, and includes an unpaired effector control mode for independent control of respective end effectors of the first and second robotic crawlers.

20. The system of claim 16, wherein the coordinated drive mode includes a quasi-paired drive mode to control operation of the mobility mechanisms of the only the first and third frame units, such that the mobility mechanisms of the second and fourth frame units are independently controllable in the quasi-paired drive mode.

21. The system of claim 20, wherein the quasi-paired drive mode includes an unpaired auxiliary control mode for independent control of the at least one articulated linkages of the first and second robotic crawlers, and independent control of end effectors of the first and second robotic crawlers.

22. The system of claim 20, wherein the quasi-paired drive mode includes a paired auxiliary control mode for coordinated control of the at least one articulated linkages of both of the first and second robotic crawlers, and for coordinated control of end effectors of the first and second robotic crawlers.

23. The system of claim 16, wherein the controller is configured to operate the unified robotic crawler system in an uncoupled control mode when the first and second robotic crawlers are uncoupled from each other to form a separated robotic crawler system, the uncoupled control mode comprising an uncoupled selective control mode for selective coordinated control of at least one function of the first and second robotic crawlers to perform a common task.

24. The system of claim 23, wherein the uncoupled control mode includes an uncoupled paired control mode for coordinated control of the first and second robotic crawlers to perform a common task.

25. The system of claim 16, wherein the at least one articulated linkage of the first and second robotic crawlers comprise a plurality of powered joint modules coupled together to facilitate actuated movement of the articulated linkage in a plurality of degrees of freedom.

26. The system of claim 16, wherein each mobility mechanism of the first, second, third, and fourth robotic crawlers comprises a continuous track.

27. A method of operating a unified robotic crawler system comprising:
obtaining first and second robotic crawlers;
coupling together the first and second robotic crawlers via at least one coupling mechanism; and
controlling operation of the first and second robotic crawlers in a coordinated drive mode.

28. The method of claim 27, further comprising controlling operation of the first and second robotic crawlers in a full paired drive mode, of the coordinated drive mode, to control operation of mobility mechanisms of the first and second robotic crawlers.

29. The method of claim 28, wherein, when in the full paired drive mode, the method further comprising selectively controlling operation of the first and second robotic crawlers in a paired effector control mode to control operation of end effectors of the first and second robotic crawlers, or in an unpaired effector control mode for independent control of end effectors of the first and second robotic crawlers.

30. The method of claim 27, further comprising controlling operation of the first and second robotic crawlers in a quasi-paired drive mode, of the coordinated drive mode, to control operation of first and second mobility mechanisms of the first and second robotic crawlers.

31. The method of claim 30, wherein, when in the quasi-paired drive mode, the method further comprising selectively controlling operation of the first and second robotic crawlers in a paired auxiliary control mode to control operation of end effectors and linkages of the first and second robotic crawlers, or in an unpaired auxiliary control mode for independent control of end effectors and linkages of the first and second robotic crawlers.

32. The method of claim 27, further comprising uncoupling the first robotic crawler from the second robotic crawler via the at least one coupling mechanism, and controlling the first and second robotic crawlers in an uncoupled control mode.

33. The method of claim 32, wherein, when in the uncoupled control mode, the method further comprising selectively controlling operation of the first and second robotic crawlers in an uncoupled selective control mode, an uncoupled paired control mode, and an uncoupled asynchronous task mode.

34. The method of claim 27, further comprising operating a coupling input device to couple together the first and second robotic crawlers with a magnetic force, wherein the at least one coupling mechanism comprises an electromagnetic device supported by one of the first or second robotic crawlers, and wherein the coupling input device controls application of a magnetic force via the electromagnetic device.

35. The method of claim 27, further comprising operating respective mobility mechanisms of the first and second robotic crawlers in the coordinated drive mode to facilitate locomotion of the first and second robotic crawlers moving as a unified robotic crawler system.

36. A method of operating a pair of robotic crawlers, comprising:
operating first and second robotic crawlers in an uncoupled control mode such that the first robotic crawler moves about a ground surface separately from the second robotic crawler;
coupling the first robotic crawler to the second robotic crawler via a coupling mechanism to form a unified robotic crawler system;
switching to a coordinated drive mode for coordinated control of mobility mechanisms of the first and second robotic crawlers; and
operating the first and second robotic crawlers in the coordinated drive mode to move together about the ground surface.

37. The method of claim 36, further comprising operating a controller to control movement of the first and second robotic crawlers.

38. The method of claim 37, further comprising operating a switch input device of the controller to facilitate switching between the coordinated drive mode and the uncoupled control mode.

39. The method of claim 36, wherein operating the first and second robotic crawlers in the coordinated drive mode further comprises selectively switching between a full paired drive mode and a quasi-paired drive mode, the full paired drive mode for coordinated control of first and second mobility mechanisms of the first robotic crawler and of second and third mobility mechanisms of the second robotic crawler, and the quasi-paired drive mode for coordinated control of the first and third mobility mechanisms of the first and second robotic crawlers.

40. The method of claim 36, wherein coupling the first robotic crawler to the second robotic crawler comprises physically attaching together the first and second robotic crawlers via the at least one coupling mechanism.

41. The method of claim 36, wherein each of the first and second robotic crawlers comprises:
first and second frame units supporting respective mobility mechanisms; and
at least one articulated linkage coupling the first and second frame units together.

42. The method of claim 40, wherein operating the first and second robotic crawlers in the coordinated drive mode further comprises selectively switching between a full paired drive mode and a quasi-paired drive mode, the full paired drive mode for coordinated control of the mobility mechanisms of the first and second frame units, and the at least one articulated linkage, of the first and second robotic crawlers.

43. The method of claim 41, further comprising switching between a paired effector control mode for coordinated control of end effectors of the first and second robotic crawlers and an unpaired effector control mode for independent control of the end effectors when in the full paired drive mode.
